(19) United States
(12) Patent Application Publication
(10) Pub. No.: US 2009/0303033 A1
(43) Pub. Date: Dec. 10, 2009

(54) Interactive advertising display

(76) Inventors: David Wiesenfeld, New City, NY (US); David Lodge, Guangdong (CN)

Correspondence Address: Klaus P. Stoffel;Wolff & Samson, One Boland Drive, West Orange, NJ, 07052, US

(21) Appl. No.: 12/157,102

(22) Filed: Jun. 6, 2008

(51) Int. Cl. G08B 1/08

(52) U.S. Cl. 340/539.1

(57) ABSTRACT

An interactive advertising display that has a display element, a transmitter operative to output a wireless signal in response to movement, and a receiver for receiving the signal from the transmitter. The receiver is connected to the display element so as to turn the display on and off in response to the signal from the transmitter.

### BACKGROUND OF THE INVENTION

The present invention relates to advertising displays. The use of illuminated or moving displays for brand advertising is well known. Such advertising displays attract more attention from consumers than do non-illuminated or static advertisements. Illuminated advertising displays that are powered by batteries and respond to sound in a bar or restaurant setting are also known but these displays only work in environments where there is music playing, in quiet bars they do not function well. What brands require is a means of advertising a product that is related directly to the use or potential use of the product in such a way that potential consumers are notified of the purchase of the product to encourage more people to buy the product

### SUMMARY OF THE INVENTION

Accordingly, it is an object of the present invention to provide an advertising display located in the public area of a bar which illuminates when a consumer buys a certain beer, for example.

Pursuant to this object, and others which will become apparent hereafter, one aspect of the present invention resides in an advertising display including a display element, a transmitter which is activated by some form of movement, and a receiver which switches on the display element in response to a signal transmitted from the transmitter. The transmitter and the receiver are separated and communication between the two is wireless. The unique aspect of this invention is that activity in one area of the bar, restaurant or shop can cause the remote switching of an advertising display in another area of the bar, restaurant or shop. The display element can be an illuminated sign or a display with a movable component.

In one embodiment, the transmitter outputs a signal in response to movement of a product associated with the display of the display element.

In still another embodiment, a switch mechanism is connected to or provided in the transmitter, whereby closing of the switch causes the transmitter to output the signal to the receiver for activating the display element.

There are various possibilities for housing the transmitter. For example, the transmitter can be housed in a bottle display so that when a bottle is removed the transmitter is activated to output the signal to the receiver for turning on the display element. Another option is to arrange the transmitter in a bottle opener so that when a bottle is opened with the opener, the transmitter is activated. The transmitter can also be mounted on a refrigerator door or formed as part of a drip tray for bottles whereby opening the refrigerator door or placing a bottle on the tray causes the transmitter to output the appropriate signal for activating the display element.

In yet a further embodiment of the invention, the transmitter includes a proximity sensor which activates the transmitter when a person approaches a sensor.

It is possible for the transmitter and receiver to operate based on radio frequency, Bluetooth™, infrared, etc. Depending on the type of wireless signal being transmitted, it is understood that those skilled in the art would know what type of transmitter and receiver to use.

Other features and advantages of the present invention will become apparent from the following description of the invention.

### BRIEF DESCRIPTION OF THE DRAWINGS

FIG. 1 is a schematic representation of the interactive display of the present invention.

FIG. 2 is a schematic representation of another embodiment.

### DETAILED DESCRIPTION OF THE INVENTION

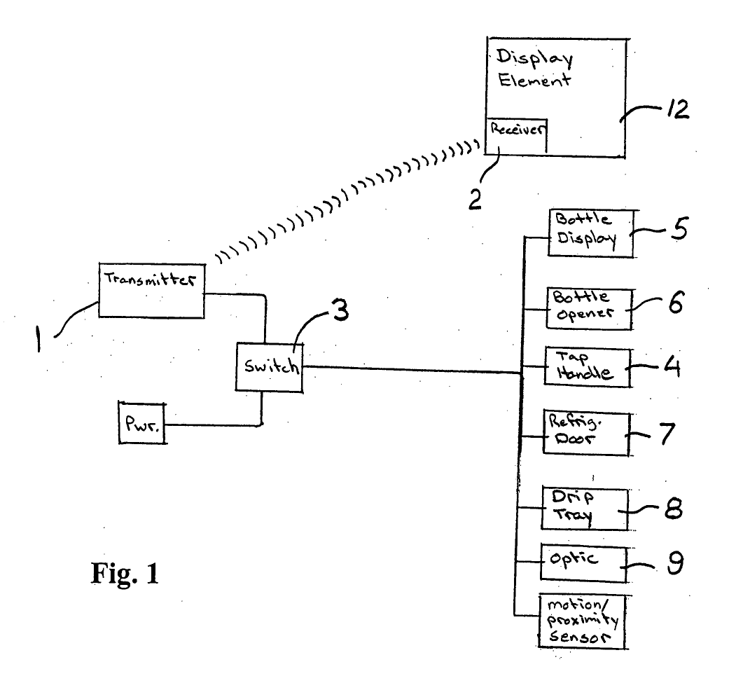

The interactive advertising display of the invention is schematically shown in FIG. 1. The display includes a radio frequency transmitter 1 that is housed in a functional piece of hardware to be located in a bar, convenience store or other public outlet. When the hardware is moved there is a switching mechanism 3 in the transmitter that switches in response to the movement (for example a tilt switch, a pressure switch, a micro switch, a PIR detector) and sends a wireless signal to a receiver 2. For example, the transmitter 1 can be located in or under a beer tap handle 4 in such a way that when draught beer is pulled from the tap the switch 3 is closed causing the transmitter 1 to send out a signal to the receiver 2. The transmitter 1 could also be housed in a bottle display 5 such that when a bottle is removed from the display the switch 3 is closed causing the transmitter 2 to operate. A further application could be to house the transmitter 2 in a bottle opener 6 so that when a bottle of beer is opened this completes an electrical circuit causing the transmitter 1 to operate. Further applications for the transmitter could be opening refrigerators 7, placing beer on a drip tray 8, pouring from an optic 9, or a proximity or motion sensor 10 for detecting a person approaching the bar.

The receiver 2 is, preferably, located up to 20 feet from the transmitter 1. The receiver 2 has no cables connecting it to the transmitter 1, making it easy to install in conventional electrical outlets. The receiver 2, when it receives the signal transmitted from the transmitter 1 operates a switch 11 that causes the advertising display element 12 to illuminate or animate in some way. Examples of this could include an illuminated sign that switches on when the transmitter 1 operates. A second application could be the use of an illuminated menu holder on a table that switches on when transmitter 1 operates. The type of sign illuminated is not within the scope of this patent application as these products are in the public domain.

There are many configurations for the inventive interactive advertising display. For example, the inventive display can comprise a transmitter housed between a beer tap handle and the beer tap which, when the beer handle is drawn backwards, causes a radio frequency transmitter in the unit to operate briefly by means of a tilt switch and cause a remotely located sign containing a radio frequency receiver of the same frequency to illuminate for a predetermined period. It is also possible for the transmitter to be housed inside a bottle display and the transmitter is activated by the removal of the bottle from the display. The transmitter can also be housed in a beer mat and the transmitter is operated by the placing of a bottle or glass of beer on the beer mat. Alternatively, the transmitter is housed in a bottle opener and the transmitter is operated by the opening of a bottle of beer. The transmitter can be housed in a refrigerator door and the transmitter operated by the opening of the door. The transmitting and receiving means can be infra red or operated by Bluetooth™.

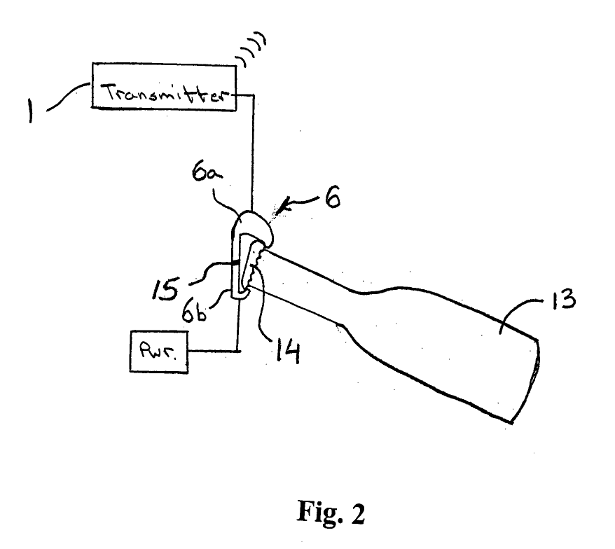

FIG. 2 schematically illustrates one embodiment of a bottle opener which can be used to activate the transmitter. In the illustrated embodiment, the bottle opener 6 is made of two parts 6a, 6b which are separated by an insulating layer 15. The parts 6a, 6b are made of a conductive metal. One of the parts 6b, is connected to a power source and the other part 6a is connected to the transmitter. When the bottle 13 is to be opened, the cap 14 is engaged in the bottle opener 6 and since the cap 14 is made of metal it closes the circuit between the bottle opener parts 6a and 6b and thereby powers the transmitter to output the signal to activate the display element 12. An alternative to producing the bottle opener 6 from two parts is to mount a switch in the bottle opener so that when the cap 14 is inserted in the bottle opener, the cap closes the switch and actuates the transmitter.

Although the present invention has been described in relation to particular embodiments thereof, many other variations and modifications and other uses will become apparent to those skilled in the art. It is preferred, therefore, that the present invention be limited but by the specific disclosure herein, but only by the appended claims.

1. An interactive advertising display, comprising:
a display element;
a transmitter operative to output a wireless signal in response to movement; and
a receiver for receiving the signal from the transmitter, the receiver being connected to the display element so as to turn the display on and off in response to the signal from the transmitter.

2. The display according to claim 1, wherein the display element has an illuminated component.

3. The display according to claim 1, wherein the display element has a moving component.

4. The display according to claim 1, wherein the transmitter outputs a signal in response to movement of a product associated with a display of the display element.

5. The display according to claim 1, wherein a switch mechanism is connected to the transmitter so that activation of the switch mechanism causes the transmitter to output the signal.

6. The display according to claim 5, wherein the transmitter is housed in a bottle display so that the switch mechanism is activated when a bottle is removed.

7. The display according to claim 1, wherein the transmitter is housed in a bottle opener whereby an electrical circuit is closed when the opener contacts a bottle cap or opens a bottle and the transmitter is activated.

8. The display according to claim 5, wherein the transmitter has a switch mounted on a beer tap handle so that the switch mechanism is closed when the handle is activated and the transmitter is activated to output the signal.

9. The display according to claim 1, wherein the transmitter is mounted on a refrigerator so that opening of a refrigerator door activates the transmitter.

10. The display according to claim 1, wherein the transmitter includes a switch mounted on a drip tray whereby placing a bottle on the tray closes the switch and activates the transmitter.

11. The display according to claim 1, wherein the transmitter includes a proximity sensor operative to activate the transmitter when a person approaches the sensor;

12. The display according to claim 1, wherein the transmitter and receiver operate on radio frequency.

13. The display according to claim 1, wherein the transmitter and receiver operate by infrared technology.

14. The display according to claim 1, wherein the transmitter and receiver operate by Bluetooth™.
